(19) United States
(12) Patent Application Publication
(10) Pub. No.: US 2008/0037084 A1
(43) Pub. Date: Feb. 14, 2008

(54) ELECTRO OPTICAL DEVICE AND ELECTRONIC APPARATUS

(75) Inventor: Hidekazu KOBAYASHI, Azumino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/695,888

(22) Filed: Apr. 3, 2007

(30) Foreign Application Priority Data
Apr. 17, 2006 (JP) 2006-112985

(51) Int. Cl. G02B 5/32

(52) U.S. Cl. 359/15

(57) ABSTRACT

An electro optical device includes a plurality of electro optical elements arranged on a surface of a first substrate, a plurality of positive diffractive lenses each for focusing a bundle of rays by diffracting light emitted from the each electro optical element, and a light shielding layer on which a plurality of apertures through which light diffracted by the each positive diffractive lens pass are formed.

### BACKGROUND

1. Technical Field

The present invention relates to an electro optical device utilizing an element in which optical property changes in accordance with electric energy (hereinafter, referred to as “electro optical element”) and an electronic apparatus equipped with the same.

2. Related Art

An electro optical device in which many electro optical elements are utilized, for example, for image display has been proposed in the past. The electro optical element such as an organic light emitting diode is an element in which an emission layer is positioned in a space between a first electrode and a second electrode opposed to each other. The first electrode has optical transparency and the second electrode has light reflectivity. The light emitted from the emission layer to the first electrode side and the light emitted from the emission layer and reflected at a surface of the second electrode are output to the outside through the first electrode.

With the structure, the outside light such as sun light and illumination light introduced to the electro optical device is reflected on a surface of the second electrode and emitted to the observation side with the light emitted from the emission layer. Accordingly, there is a problem in that contrast of image is reduced. In order to solve the above problem, a structure in which a circularly polarizing plate is placed at the observation side (light outputting side) of each electro optical element is disclosed in JP-A-8-321381 (hereinafter, referred to as Patent Document 1) and JP-A-2006-18187 (hereinafter, referred to as Patent Document 2).

However, with the structures of Patent Document 1 and Patent Document 2, a part of the light emitted from the emission layer is also shielded (absorbed) by the circularly polarizing plate with the outside light. Accordingly, there is a problem in that keeping the utilization efficiency of the light emitted from each electro optical element (hereinafter, simply referred to as “light utilization efficiency”) at high level is difficult.

### SUMMARY

An advantage of some aspects of the invention is that it provides an electro optical device including a plurality of electro optical elements arranged on a surface of a first substrate (for example, the substrate 10 in FIGS. 1 and 4), a plurality of positive diffractive lenses (for example, the hologram lens 61 in FIGS. 1 and 4) each for focusing a bundle of rays by diffracting light emitted from the each electro optical element, and a light shielding layer on which a plurality of apertures through which light diffracted by the each positive diffractive lens pass are formed. The positive diffractive lens is a diffractive optical element functions as a positive lens.

According to the invention, the light shielding layer is formed opposite to the electro optical element with the positive diffractive lens interposed therebetween, so that introduction of the outside light (sunlight and illumination light) into the electro optical device is restricted. Accordingly, contrast of image can be improved by sufficiently reducing gray scale of black even under the circumstance of strong outside light. In addition, the light emitted from each optical light element is focused by the positive diffractive lens and thereafter passed through the aperture, and emitted to the observation side. Accordingly, as compared with the structure in which a circularly polarizing plate is placed as in, for example, Patent document 1 and Patent Document 2, light utilization efficiency can be maintained at a high level.

In a preferable aspect of the invention, a coloring layer through which a component of light passing through the each aperture corresponding to any of a plurality of colors is selectively transmitted is placed. The light emitted from each electro optical element is concentrated on the coloring layer by the positive diffractive lens.

Accordingly, the amount of light emitted from one electro optical element and reached to the coloring layer for the adjacent electro optical element is reduced. Accordingly, color reproductivity and contrast can be improved.

In a preferred embodiment of the electro optical device utilized for image display, a diffusion layer for diffusing light transmitted through the coloring layer is placed. Directivity of the light emitted from each electro optical element is enhanced by the positive diffractive lens. In the aspect in which the diffusion layer is disposed, the emission light from the positive diffractive lens is appropriately diffused and thereafter emitted to the observation side. Accordingly, as compared with the structure in which the diffusion layer is not placed, viewing angle range can be widened.

In a first aspect of the invention (for example, a first embodiment described below), each of the plurality of the positive diffractive lenses is disposed on a surface of the first substrate opposite to the surface on which the plurality of electro optical elements are arranged and is a transmission type hologram lens for focusing light transmitted through the first substrate, and the light shielding layer is disposed at a side opposite to the first substrate with the plurality of positive diffractive lenses interposed therebetween. Further, a second substrate (for example, the substrate 50 in FIG. 2) having optical transparency opposing the first substrate with the plurality of positive diffractive lenses interposed therebetween is disposed, and the light shielding layer is formed on a surface of the second substrate opposite to the first substrate. According to the aspect, the electro optical device is constructed by bonding the first substrate on which each electro optical element is formed and the second substrate on which the light shielding layer is formed. Accordingly, the light shielding layer can be formed by a process independent from the elements on the first substrate. Note that, the plurality of positive diffractive lenses may be formed on any of the first substrate and the second substrate.

In the electro optical device according to the first aspect, a coloring layer is placed on a surface of the second substrate opposite to the first substrate. According to the aspect, the coloring layer can be formed by a process independent from the elements on the first substrate. For example, the coloring layer formed by a resin material includes relatively a lot of fluid. According to the aspect, the coloring layer is formed on the second substrate independent from the elements of the first substrate. Accordingly, there is an advantage in that the possibility for deteriorating the elements caused by adhesion of the fluid in the coloring layer to the elements on the first substrate is reduced. Since the deterioration of the electro optical element such as an organic light emitting diode element caused by adhesion of fluid is remarkable, the above aspect is particularly preferable for the electro optical device in which an organic, light emitting diode element is employed as the electro optical element.

In the electro optical device according to the first aspect, the first substrate and the second substrate are bonded by an optical transparency adhesive agent having a same reflective index as at least any one of the first substrate and the second substrate. According to the aspect, reflection and refraction at the boundary face between the first substrate or the second substrate and the adhesive agent are restricted. Accordingly, as compared with the stricture in which the adhesive agent having a different refractive index as the first substrate or the second substrate is utilized, amount of light reached to the positive diffractive lens or the aperture among the light emitted from each electro optical element can be sufficiently assured.

In the electro optical device according to the first aspect, when a thickness of the first substrate D1 and a thickness of the second substrate D2 satisfy a relation of “0.5×D1<D2<0.8×D1” in the structure, the light shielding layer (aperture) can be placed at the position where the light diffracted by the positive diffractive lens is focused to near the minimum light, flux width. Accordingly contrast of image can be improved by reducing the area of the aperture while maintaining the amount of the light passing through the aperture.

In the electro optical device according to a second aspect of the invention (for example, a second embodiment described below), each of the plurality of positive diffractive lenses is disposed on a surface of the first substrate opposite to the surface on which the plurality of electro optical elements are arranged, and is a reflection type hologram lens for reflecting and focusing light transmitted through the first substrate, and the light shielding layer is disposed at a side opposite to the plurality of positive diffractive lenses with the first substrate interposed therebetween. According to the above structure, although a bottom emission type electro optical element is used, the light emitted from each electro optical element can be emitted to the side opposite (top emission type) to the first substrate with the electro optical element interposed therebetween.

In the electro optical device according to the second aspect, the each electro optical element is a light emitting element including an emission layer for emitting light by application of electric energy, a first electrode having optical transparency positioned between the emission layer and the each positive diffractive lens, a second electrode opposing the first electrode with the emission layer interposed therebetween, and the second electrode of the each electro optical element is a contiguous conducting layer having light reflectivity over the plurality of electro optical elements and having an aperture through which light diffracted by the each positive diffractive lens passes. According to the above aspect, the aperture is formed in the second electrode, so that the light diffracted by the positive diffractive lens can be surely emitted.

In the electro optical device according to the second aspect, for example, a sealing substrate for covering a surface of the first substrate on which the plurality of electro optical elements are arranged is further included and the light shielding layer is formed on a surface of the sealing substrate. According to the above aspect, the sealing substrate is used not only for the sealing (blocking the outside air) of each electro optical element but also for supporting the light shielding layer. Accordingly, the structure of the electro optical device is simplified as compared with the structure in which the light shielding layer is formed by a separate member as the sealing substrate.

A coloring layer through which a component of the light passing through the each aperture corresponding to any of a plurality of colors is selectively transmitted is further included and the light shielding layer and the coloring layer are disposed on a surface of the sealing substrate opposing the first substrate. According to the above structure, the coloring layer approaches the positive diffractive lens as compared with the structure in which the coloring layer is formed on a surface of the sealing substrate opposite to the first substrate. Accordingly, it becomes possible that the amount of the light introduced into the coloring layer among the light diffracted by the positive diffractive lens is sufficiently assured.

The electro optical device according to the invention may be utilized in various kinds of electronic apparatuses. A typical example of the electronic apparatus is an apparatus utilizing the electro optical device as a display device. As for such a type of electronic apparatus, there is a personal computer, a cellular phone, and the like. However, the application of the electro optical device according to the invention is not restricted to image display. The electro optical device of the invention can be applied to various applications, for example, such as an exposure device (exposure head) for forming a latent image on an image carrying body such as a photoreceptor drum or the like by emission of light ray, a device (back light) disposed at the rear surface side of a liquid crystal device and illuminating the liquid crystal device, various kinds of illuminating devices such as a device mounted in an image reading device such as a scanner and for illuminating a manuscript, or the like.

### BRIEF DESCRIPTION OF THE DRAWINGS

The invention will be described with reference to the accompanying drawings, wherein like numbers reference like elements.

FIG. 1 is a cross sectional view showing a structure of an electro optical device according to a first embodiment of the invention.

FIG. 2 is a cross sectional view showing an appearance where substrates are bonded.

FIG. 3 is a cross sectional view for illustrating conditions of the size of each portion.

FIG. 4 is a cross sectional view showing a structure of an electro optical device according to a second embodiment of the invention.

FIG. 5 is a perspective view showing a structure of an embodiment (personal computer) of an electronic apparatus according to the invention.

FIG. 6 is a perspective view showing a structure of an embodiment (cellular phone) of the electronic apparatus according to the invention.

FIG. 7 is a perspective view showing a structure of an embodiment (personal digital assistant) of the electronic apparatus according to the invention.

### DESCRIPTION OF EXEMPLARY EMBODIMENTS

### A: First Embodiment

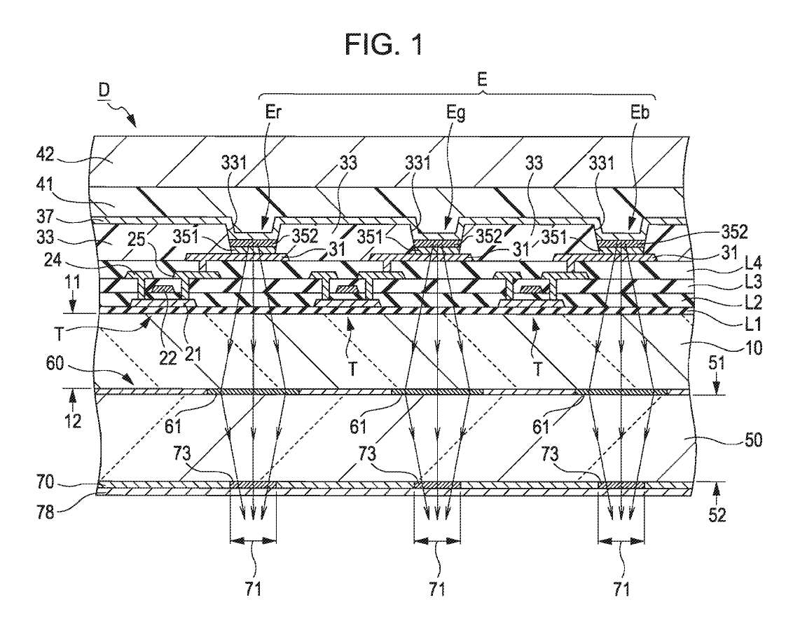

A specific embodiment of an electro optical device utilized for image display will be described with reference to FIG. 1. As shown in FIG. 1, the electro optical device D includes many electro optical elements E (Er•Eg•Eb) arranged on one surface (hereinafter, referred to as “first surface”) 11 of a substrate 10. The electro optical element E is an organic light emitting diode element (light emitting element). The electro optical elements Er is utilized for displaying red, the electro optical element Eg is utilized for displaying green, and the electro optical element Eb is utilized for displaying blue.

The substrate 10 is a flat plate having optical transparency formed by glass, plastic, or the like. The first surface 11 of the substrate 10 is covered by an insulating layer L1 over the whole region. A plurality of transistors T corresponding to the electro optical elements E are formed on the surface of the insulating layer L1. The transistor T is means for controlling electric energy (electric current) supplied to the electro optical element E in accordance with the electrical potential of a gate electrode 22. The transistor T includes a semiconductor-layer 21 formed on a surface of the insulating layer L1 by a semiconductor material such as polysilicon and a gate electrode 22 opposing the semiconductor layer 21 with an insulating layer (gate insulating layer) L2 interposed therebetween. The gate electrode 22 is covered by an insulating layer L3. A source electrode 24 and a drain electrode 25 of the transistor T are formed on a surface of an insulating layer L3 and electrically connected to the semiconductor layer 21 (source region-drain region) via contact holes of the insulating layers L2•L3. A surface of the substrate 10 on which the driving transistor T is formed is covered by an insulating layer L4. Each of the insulating layers L1 to L4 is a film formed by an insulating material having optical transparency such as SiO₂, SiNₓ.

As shown in FIG. 1, First electrodes (positive electrode) 31 are formed on the surface of the insulating layer L4 for each electro optical element E with a space. The first electrode 31 is formed by an electrical conducting material having optical transparency such as ITO (Indium Tin Oxide) or the like and electrically connected to the drain electrode 25 of the transistor T through a contact hole in the insulating layer L4. An isolating layer 33 is formed on the surface of the insulating layer L4 on which the first electrode 31 is formed. The isolating layer 33 is a film formed by an insulating material such as a photosensitive resin material (for example, acrylic) or the like. In the isolating layer 33, aperture 331 is formed in each region overlapping the first electrode 31 when viewed from the direction perpendicular to the substrate 10 (up and down direction in FIG. 1).

A hole injecting layer 351 and an emission layer 352 are formed in the space which is surrounded by the inner circumference surface of the aperture 331 of the isolating layer 33 and formed on the first electrode 31 as the bottom, surface in this order. The hole injection layer 351 is formed by, for example, polythiophene (PEDOT) chemically-doped by acid (PSS). The emission layer 352 is a film formed by an organic EL (Electroluminescence) material. The emission layer 352 of each electro optical element E having different display color is formed by a separate material. That is, the emission layer 352 of the electro optical element Er is formed by an emission material which emits light (red color light) having the wavelength corresponding to red color. Similarly, the emission layer 352 of the electro optical element Eg is formed by an emission material which emits green color light and the emission layer 352 of the electro optical element Eb is formed by an emission material which emits blue color light. Note that, various function layers (a hole transport layer, an electron injection layer, an electron transport layer, a hole blocking layer, an electron blocking layer) for promoting or streamlining of the emission by the emission layer 352 may be laminated on the emission layer 352 in the structure.

A second electrode 37 is formed on the isolating layer 33 and the emission layer 352. The second electrode 37 is a contiguous conducting layer having light reflectivity formed over the plurality of electro optical element E. The second electrode 37 is formed by an electrical conducting material having a low work function than the first electrode 31, and functions as a negative electrode of the electro optical element E. The portion at which the first electrode 31 and the second electrode 37 are opposed with the emission layer 352 interposed therebetween (the portion inside of the aperture 331) is equivalent to the electro optical element E. The light emitted from the emission layer 352 to the substrate 10 side and the light reflected at the surface of the second electrode 37 is diffusively transmitted through the first electrode 31, the insulating layers L1 to L4, and the substrate 10.

A sealing substrate 42 is adhered on the first surface 11 of the substrate 10 on which the above elements are formed by an adhesive agent 41. The sealing substrate 42 is a flat plate for preventing adhesion of outside air and moisture by sealing each electro optical element E between the substrate 10 and the sealing substrate 42. The adhesive agent 41 is a resin material such as epoxy or the like filled in the space between the substrate 10 and the sealing substrate 42. The light emitted from each electro optical element E is emitted to substrate 10 side (bottom emission type), so that no optical transparency is required for the sealing substrate 42. Note that, the structure in which the adhesive agent 41 is filled between the substrate 10 and the sealing substrate 42 is exemplified here. However, a can sealing in which a sealing material having a shape in which the rim is projected to the substrate 10 side is bonded to the substrate 10 (structure in which each electro optic element E is sealed in the closed space between the sealing material and the substrate 10) may be employed. An inactive gas or a desiccant agent is enclosed into the space surrounded by the sealing material and the substrate 10. According to the structure, there is an advantage in that possibility of deterioration of the second electrodes 37 is reduced and the lifetime is increased.

A substrate 50 is bonded on a surface 12 of the substrate 10 opposite to the first surface 11 (hereinafter, referred to as “second surface”). The substrate 50 is a flat plate having optical transparency formed by glass, plastic, or the like. A hologram lens array 60 is disposed on a surface 51 of the substrate 50 opposing the substrate 10 (hereinafter, referred to as “first surface”). The hologram lens array 60 includes many hologram lenses 61 arranged in an array mariner on the first surface 51.

When viewed from the direction perpendicular to the substrate 10 (direction of the optical axis of hologram lens 61), each hologram lens 61 overlaps each electro optical element E. To be more specific, the optical axis of one hologram lens 61 passes through the center of one electro optical element E corresponding thereto. As shown in FIG. 1, each hologram lens 61 is a transmission type positive diffractive lens for focusing the bundle of rays emitted from the electro optical element E which overlaps the hologram lens 61 and transmitted through the substrate 10 by diffraction. In the embodiment, the hologram lens 61 in which phase distribution φ (r) in which distance r from light axis shall be a parameter is expressed by equation (1) is employed. Such a hologram lens 61 is formed by exposing a pattern prepared with, for example, a CGH (Computer Generated Hologram) by a photographic method.

$$φ ( r ) = {\sum }_{n = 1}^{10} {C}_{n} {r}^{2 n} \qquad ( 1 )$$

C1 to C10 in the equation (1) are constant numbers selected in accordance with optical properties required for the hologram lens 61. In the embodiment, the wavelength of the light introduced into each hologram lens 61 is different in accordance with a display color of the electro optical element E. Accordingly, the constant numbers C1 to C10 for each hologram lens 61 are separately selected so that the optical property of the hologram lens 61 corresponding to each electro optical element E having different display-color is to be different.

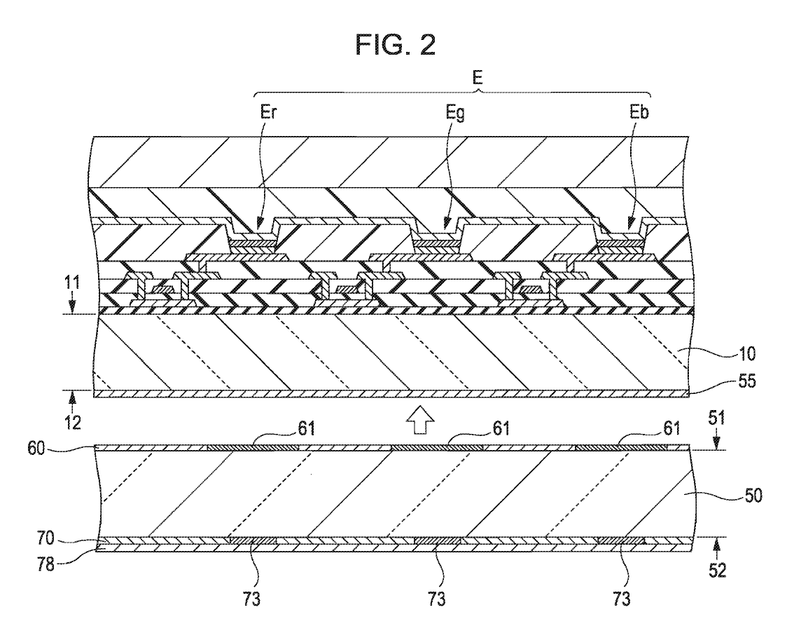

As shown in FIG. 2, the first surface 51 of the substrate 50 on which the hologram lens array 60 is formed is bonded on the second surface 12 of the substrate 10 through an adhesive agent 55 having optical transparency. The refractive index of the adhesive agent 55 is the same as the refractive index of at least one of the substrate 10 and the substrate 50. With the structure, the light reflection between the second surface 12 of the substrate 10 and the first surface 51 of the substrate 50 is reduce.

Accordingly, as compared with the structure in which the substrate 10 and the substrate 50 are bonded with an adhesive agent having a different refractive index as the substrate 10 and the substrate 50, the ratio of the amount of light introduced into the hologram lens 61 among the light emitted from each electro optical element E can be sufficiently assured.

As shown in FIG. 1, a light shielding layer 70 is formed on a surface 52 of the substrate 50 opposite to the substrate 10 (hereinafter, referred to as “second surface”). A plurality of (the same number as the electro optical element E) apertures 71 respectively corresponding to the separate electro optical elements E are formed in the light shielding layer 70. Each aperture 71 is a small aperture which passes through the light shielding layer 70 in the thickness direction and the shape viewed from the direction perpendicular to the substrate 10 is homothetic to the electro optical element E. One aperture 71 overlaps the electro optical element E and the hologram lens 61 when viewed from the direction perpendicular to the substrate 10. To be more specific, the optical axis of one aperture 61 passes through the center of one aperture 71 corresponding thereto.

The light shielding layer 70 is formed by, for example, selectively removing the region corresponding to each aperture 71 among a film having light blocking effect formed on the whole region of the second surface 52 of the substrate 50 by a photolithography technique or an etching technique. As for materials of the light shielding layer 70, for example, a resin material in which carbon blacks are dispersed or a metal oxide material (for example, chrome oxide) having low reflectivity is preferably employed.

A coloring layer (color filter) 73 corresponding to each display color is formed on the inside of each aperture 71. Accordingly, one coloring layer 73 and one electro optical element E overlaps each other when viewed from the direction perpendicular to the substrate 10. The coloring layer 73 is a film for selectively transmitting the wavelength component corresponding to a certain display color among the emission light from the hologram lens 61 which passes through the aperture 71. The coloring layer 73 which overlaps the electric optical element Er for red transmits red color light, the coloring layer 73 which overlaps the electric optical element Eg for green transmits green color light, and the coloring layer 73 which overlaps the electric optical element Eb for blue transmits blue color light. Note that, the reason why the coloring layer 73 is provided in addition to the structure in which the emission layer 352 of each electro optical element E is formed by a separate material for each display color (the structure in which color light corresponding to each display color is emitted from each electro optical element E) is that the selecting the material of the emission layer 352 only is not necessarily enough to obtain a predetermined emission property. In other words, when color light having a predetermined property is emitted from the emission layer 352, the coloring layer 73 may be properly omitted.

The light emitted from each electro optical element E and focused by the hologram lens 61 is introduced into the coloring layer 73 and only the wavelength component belonging to the range corresponding to a display color is selectively emitted. On the other hand, the component reached to the region except the apertures 71 (coloring layers 73) from the substrate 10 side is shielded by the shield layer 70, so that the component is prevented from being emitted to the observation side. In addition, most of outside light such as sunlight, illumination light, and the like is shielded by the light shielding layer 70.

Accordingly, the light, does not reach the inside of the electro optical device D.

A diffusion layer 78 is placed on the surface of the light shielding layer 70 and the coloring layer 73. The diffusion layer 78 is an optical transparency member which diffuses the light transmitted through the coloring layer 73. For example, as for the diffusion layer 78, the film in which many fine particles having optical transparency are dispersed in an optical transparency resin material having the different refractive index or the optical transparency film having a surface on which many fine concavities and convexities are formed are employed. The light transmitted through the diffusion layer 78 is emitted to the observation side and perceived by an observer. The light diffracted by the hologram lens 61 has a high directivity, so that there is a case that ensuring sufficient viewing angle range may be hard when the emission light from the coloring layer 73 is directly emitted (not through the diffusion layer 78) to the observation side. In the embodiment, the emission light from the coloring layer 73 is moderately diffused by the diffusion layer 78, so that there is an advantage in that sufficient viewing angle range can be ensured.

As described above, in the embodiment, the light emitted from each electro optical element E is focused by the hologram lens 61 and thereafter passed through the aperture 71 and emitted to the observation side.

Accordingly, as compared with the structure in which a circularly polarizing plate is placed, for example, as in Patent Document 1 and Patent Document 2, light utilization efficiency can be maintained at a high level. Further, the region except the apertures 71 is covered by the light shielding layer 70, so that introduction of the outside light (sunlight, illumination light) into the electro optical device D is restricted. Accordingly, even under the circumstance of strong outside light, contrast of image can be improved by setting black at sufficiently low gray scale.

Further, the light emitted from each electro optical element E is diffracted by the hologram lens 61 and thereafter introduced into the coloring layer 73, so that among the light emitted from an electro optical device E corresponding to one display color, the amount of light reaches a coloring layer 73 for another display color adjacent thereto is reduced. That is, the light emitted from one electro optical element E is introduced into one coloring layer 73 corresponding to the electro optical element E at a high accuracy. Accordingly, color reproducibility and contrast can be improved as compared with the structure in which the light emitted from each electro optical element E is emitted to the observation side without passing through the hologram lens 61.

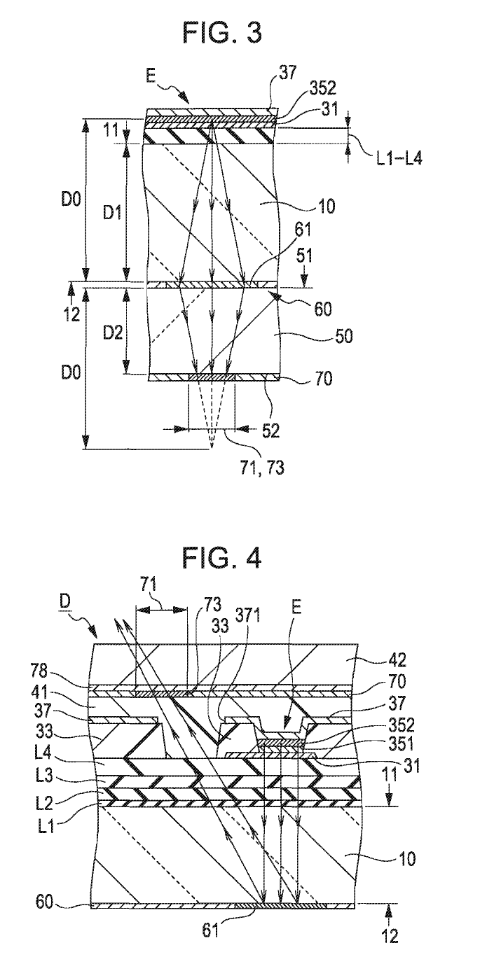

Then, conditions of each element of the electro optical device D according to the embodiment will be described with reference to FIG. 3. Suppose that sufficient amount of light is emitted from each aperture 71, the smaller the area of each aperture 71 (the region covered by the shielding layer 70 is large), the more the black gray scale is lowered and contrast of image is improved. Accordingly, in order to improve contrast of image while sufficiently keeping ratio of amount of light introduced into the coloring layer 73 among the light emitted from each electro optical element E, the light shielding layer 70 and the coloring layer 73 are disposed at the position (imaging position) at which light flux width of the light diffracted by the hologram lens 61 becomes minimum. That is, the distance D2 (thickness of the substrate 50) between the light emitting surface of the hologram lens 61 (first surface 51) and the surface of the coloring layer 73 at the substrate 50 side (second surface 52) is preferable to be selected so as to match the focal length D0 of the hologram lens 61 as a matter of form.

However, the actual light flux width of the light diffracted by the hologram lens 61 is minimized at the position in front of the logical imaging position (the position spaced apart by distance D0 from the first surface 51). To be more specific, the light flux width of the diffracted light is minimized at the position spaced apart by distance D2 specified by the following equation (2) from the light emission surface of the hologram lens 61,

0.5×D0<D2<0.8×D0 (2)

Accordingly, the size of the thickness D2 of the substrate 50 is set within the scope of the equation (2) so that the light shielding layer 70 and the coloring layer 73 are disposed at the position where the light flux width of the light diffracted by the hologram lens 61 is fully narrowed. To be more specific, the flux width of the diffracted light is minimized at the point spaced apart by “0.6×D0” from the light emitting surface of the hologram lens 61. Accordingly, the structure in which the thickness D2 of the substrate 50 is set to “0.6×D0” is particularly preferable.

Note that, as shown in FIG. 3, the focal length D0 of the image side is equal to the distance (focal length of material body side) D0 from the emission layer 352 of each electro optical element E to the light entering surface of the hologram lens 61. In this regard, the distance (summation of the film thickness of the insulating layers L1 to L4 and the first electrode 31) from the first surface 11 of the substrate 10 to the emission layer 352 is fully short as compared with the thickness D1 of the substrate 10 (for example, 0.5 mm). Accordingly, the focal length D0 can be regarded approximately the same as the thickness D1 of the substrate 10. Accordingly, the thickness D2 of the substrate 50 is selected from the range of the equation (3) described below, and more preferably, set to “0.6×D1”. According to the structure in which the thickness D2 is selected so as to satisfy the above described conditions, the desired effect for improving light utilization efficiency and contrast becomes increasingly prominent.

0.5×D1<D2<0.8×D1 (3)

### B: Second Embodiment

Next, a second embodiment of the invention will be described with reference to FIG. 4. Only the elements corresponding to one display color is illustrated in FIG. 4. However, the structure of the elements corresponding to the other two display colors is the same as in the first embodiment. Further, elements such as the transistors T or the like are appropriately omitted. In addition, like reference numerals are used to denote the elements having the same operation and function as the first embodiment in the embodiment, so that the detail description thereof will be appropriately omitted.

As shown in FIG. 4, in the embodiment, the hologram lens array 60 is placed on the second surface 12 of the substrate 10. The hologram lens array 60 includes many hologram lenses 61 arranged in an array manner so as to overlap each electro optical element E when viewed from the direction perpendicular to the substrate 10. Each hologram lens 61 is a reflection type positive diffractive lens for reflecting (diffractively reflecting) and focusing the light introduced from each electro optical element E at a predetermined angle. The point in which the hologram lens 61 corresponding to the electro optical element E of each display color has a different property in accordance with the display color is the same as the first embodiment.

As shown in FIG. 4, a portion on the optical path of the light diffracted (reflected) by the hologram lens 61 among the isolating layer 33 is removed. Similarly, an aperture 371 which passes through the second electrode 37 in the thickness direction is formed in a region on the optical path of the light diffracted by the hologram lens 61 among the second electrode 37.

As shown in FIG. 4, the shielding layer 70 and the diffusion layer 78 are formed on the surface of the sealing substrate 42 opposing the substrate 10 in this order. The aperture 71 is formed in a region in which the light diffracted by the hologram lens 61 reaches among the shielding layer 70. A coloring layer 73 corresponding to a display color of the electro optical device E is formed inside each aperture 71. Note that the light shielding layer 70, the coloring layer 73, and the diffusion layer 78 may be formed on the surface of the sealing substrate 42 opposite to the substrate 10. As described above, according to the structure in which the sealing substrate 42 for sealing the electro optical element E doubles as a member for supporting the shielding layer 70, the coloring layer 73, and the diffusion layer 78, there is an advantage in that the structure of the electro optical device D becomes simple as compared with the structure in which the plate material on which the elements are disposed is separately disposed from the sealing substrate 42.

With the structure described above, the light emitted from each electro optical element E transmits through the substrate 10 and is introduced into the hologram lens 61. The light introduced into the hologram lens 61 is diffractively reflected toward the direction making a predetermined angle with respect to the introducing direction and proceeds as being focused. The light diffracted by the hologram lens 61 passes through the aperture 371 of the second electrode 37 while proceeding the inside of the adhesive bond 41, going through wavelength selection by the coloring layer 73 and spreading by the diffusion layer 78, and thereafter passing through the sealing substrate 42, and is emitted to the observation side (upward in FIG. 4). As described above, the light emitted from each electro optical element E is focused by the hologram lens 61 and passes through the aperture 71, so that the same effect as the first embodiment can be achieved in the embodiment.

Incidentally, a top emission type electro optical device in which light is emitted at the side opposite to the substrate with the structure in which the positive electrode of the electro optical element E is to have light reflectivity and the negative electrode of the electro optical element E is to have optical transparency has been proposed in the past. In the structure, the negative electrode needs to be formed by an electrical conducting material which satisfies the conditions, having lower work function than the positive electrode and having optical transparency. However, it is not necessarily easy to select a preferable material which satisfies the above conditions. In the embodiment, there is an advantage in that the same effect as the top emission type in which light is emitted to the side opposite to the substrate 10 can be provided with the structure equivalent to the conventional bottom emission type structure (the structure in which the positive electrode has optical transparency and the negative electrode has light reflexivity).

### C: Modifications

Variety of modifications can be made to each embodiment described above. Specific modifications will be described as below. It should be noted here that each modification described below can be appropriately combined.

### Modification 1

In each embodiment described above, the structure in which the emission layer 352 of each electro optical element E is formed by a separate material for each display color is exemplified. However, in the structure in which the coloring layer 73 of each display color is placed, all of the emission layers 352 of the electro optical elements E may be formed by a light emitting material which emits white light. Further, the structure in which the emission layer 352 is separated by the isolating layer 33 for each electro optical element E is not essential in the invention and the structure in which a contiguous emission layer 352 which emits white light over a plurality of elector optical elements E may be employed. With the structure, a component of the color light corresponding to a display color of the electro optical element E among the light emitted from the electro optical element E is selectively emitted from the coloring layer 73. For the formation of the contiguous emission layer 352 over a plurality of electro optical elements E, a low cost coating technique such as a spin coat method can be employed.

### Modification 2

In the second embodiment, the structure in which a portion on the optical path of the light diffracted by the hologram lens 61 among the isolating layer 33 is removed is exemplified. However, when the isolating layer 33 is formed by an optical transparency material, it is not necessarily needed to remove the portion. Further, in FIG. 4, the structure in which the insulating layers L1 to L4 are formed over the whole surface of the substrate 10 is exemplified. However, a portion on the optical path of the light diffracted by the hologram lens 61 among each of the insulating layers L1 to L4 may be removed in the structure. According to the structure, optical reflection and refraction at the boundary face of each isolating layer is prevented, so that there is an advantage in that the ratio of amount of light reached to the coloring layer 73 among the light diffracted by the hologram lens 61 can be sufficiently assured.

### Modification 3

The organic light emitting diode element is only an example of the electro optical element E. As for the electro optical element applied in the invention, there is no need to make distinction between the element which emit light by itself and the element which changes transmittance of outside light (for example, liquid crystal element) and the distinction between the current driven type element driven by supply of current and the voltage driven type element driven by application of voltage. Various electro optical elements are utilized in the invention such as, for example, an inorganic EL element, a field emission (FE) element, a surface-conduction electron-emitter (SE) element, a ballistic electron surface emitting (BS) element, a light emitting diode (LED) element, a liquid crystal element, and the like.

### D: Applications

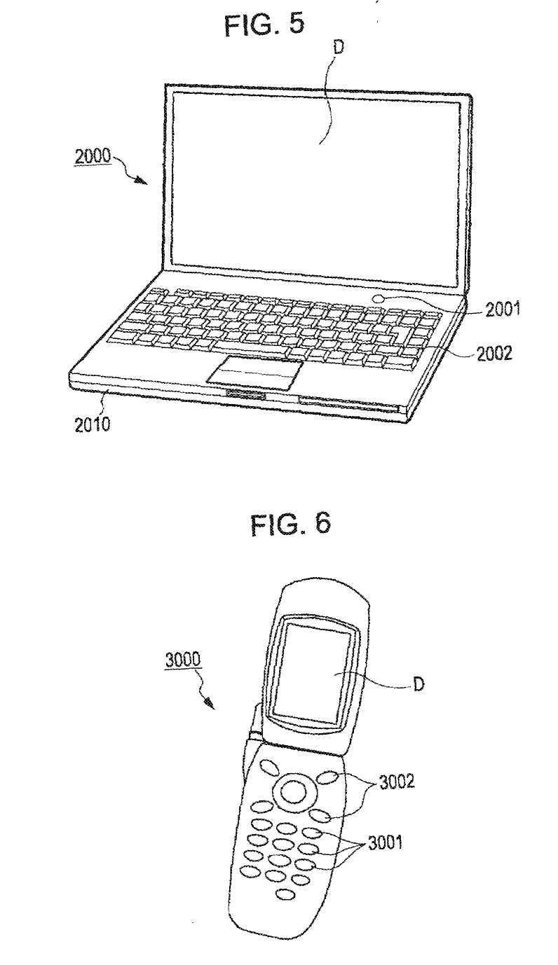

Next, an electronic apparatus utilizing the electro optical device according to the invention will be described. An embodiment of the electronic apparatus to which the electro optical device D according to any of the above embodiments is employed as a display device is illustrated in FIG. 5 to FIG. 7.

FIG. 5 is a perspective view showing a structure of a mobile personal computer employing the electro optical device D. A personal computer 2000 includes an electro optical device D for displaying various kinds of images and a main body 2010 in which a power supply switch 2001 and a keyboard 2002 are set. Since the electro optical device D uses an organic light emitting diode element as an electro optical element E, it is possible to display an image with a wide viewing angle range and excellent visibility on the screen.

FIG. 6 is a perspective view showing a structure of a cellular phone to which the electro optical device D is applied. A cellular phone 3000 includes a plurality of operation buttons 3001, scroll buttons 3002, and the electro optical device D for displaying various kinds of images. By operating the scroll buttons 3002, the screen displayed in the electro optical device D is scrolled.

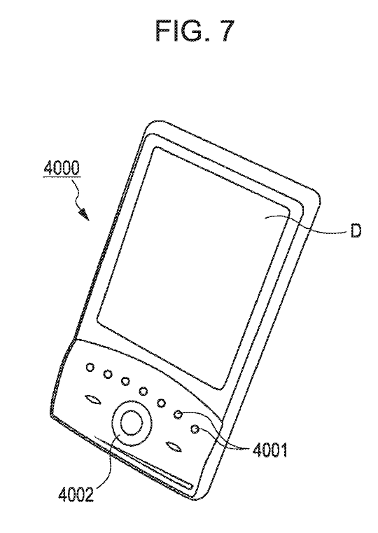

FIG. 7 is a perspective view showing a structure of a personal digital assistant (PDA) to which the electro optical device D is applied. A personal digital assistant 4000 includes a plurality of operation buttons 4001, a power supply switch 4002, and the electro optical device D for displaying various kinds of images. By operating the power supply switch, various kinds of information items, such as an address book and a schedule book, are displayed on the electro optical device D.

It should be noted here that as for electronic apparatuses to which the electro optical device according to the invention is applied, in addition to the apparatuses shown in FIG. 5 to FIG. 7, there are included a digital still camera, a television, a video camera, a car navigation apparatus, a pager, an electronic organizer, an electronic paper, an electronic calculator, a word processor, a workstation, a television phone, a POS terminal, a printer, a scanner, a duplicating machine, a video player, an apparatuses having a touch panel, and the like. Further, application of the electro optical apparatus according to the invention is not limited to image display. For example, in an image formation apparatus such as an optical writing type printer and an electronic duplicating machine, an optical head (writing head) for exposing a photoreceptor in accordance, with an image to be formed on a recording material such as a paper sheet is used. The electro optical device of the invention may be also utilized for such a type of optical head.

The entire disclosure of Japanese Application No. 2006-112985, filed Apr. 17, 2006 is expressly incorporated by reference herein.

What is claimed is:

1. An electro optical device comprising:
a plurality of electro optical elements arranged on a surface of a first substrate;
a plurality of positive diffractive lenses each for focusing a bundle of rays by diffracting light emitted from the each electro optical element; and
a light shielding layer on which a plurality of apertures through which light diffracted by the each positive diffractive lens pass are formed.

2. The electro optical device according to claim 1, further comprising a coloring layer through which a component of light passing through the each aperture corresponding to any of a plurality of colors is selectively transmitted.

3. The electro optical device according to claim 2, further comprising a diffusion layer for diffusing light transmitted through the coloring layer.

4. The electro optical device according to claim 1, wherein each of the plurality of the positive diffractive lenses is disposed on a surface of the first substrate opposite to the surface on which the plurality of electro optical elements are arranged and is a transmission type hologram lens for focusing light transmitted through the first substrate, and
the light shielding layer is disposed at a side opposite to the first substrate with the plurality of positive diffractive lenses interposed therebetween.

5. The electro optical device according to claim 4, further comprising a second substrate having optical transparency opposing the first substrate with the plurality of positive diffractive lenses interposed therebetween, and wherein
the light shielding layer is formed on a surface of the second substrate opposite to the first substrate.

6. The electro optical device according to claim 5, further comprising a coloring layer placed on a surface of the second substrate opposite to the first substrate and for selectively transmits a component of light passing through the each aperture corresponding to any of a plurality of colors.

7. The electro optical device according to claim 5, wherein the first substrate and the second substrate are bonded by an optical transparency adhesive agent having a same reflective index as at least any one of the first substrate and the second substrate.

8. The electro optical device according to claim 7, wherein a thickness of the first substrate D1 and a thickness of the second substrate D2 satisfy a relation of 0.5×D1<D2<0.8×D1.

9. The electro optical device according to claim 1, wherein each of the plurality of positive diffractive lenses is disposed on a surface of the first substrate opposite to the surface on which the plurality of electro optical elements are arranged, and is a reflection type hologram lens for reflecting and focusing light transmitted through the first substrate, and
the light shielding layer is disposed at a side opposite to the plurality of positive diffractive lenses with the first substrate interposed therebetween.

10. The electro optical device according to claim 9, wherein the each electro optical element is a light emitting element including an emission layer for emitting light by application of electric energy, a first electrode having optical transparency positioned between the emission layer and the each positive diffractive lens, a second electrode opposing the first electrode with the emission layer interposed therebetween, and
the second electrode of the each electro optical element is a contiguous conducting layer having light reflectivity over the plurality of electro optical elements and having an aperture through which light diffracted by the each positive diffractive lens passes.

11. The electro optical device according to claim 10, further comprising a sealing substrate for covering a surface of the first substrate on which the plurality of electro optical elements are arranged, and wherein
the light shielding layer is formed on a surface of the sealing substrate.

12. The electro optical device according to claim 11, further comprising a coloring layer through which a component of light passing through the each aperture corresponding to any of a plurality of colors is selectively transmitted, and wherein
the light shielding layer and the coloring layer are disposed on a surface of the sealing substrate opposing the first substrate.

13. An electronic apparatus comprising the electro optical device according to claim 1.
